(19) United States
(12) Patent Application Publication
(10) Pub. No.: US 2004/0130154 A1
(43) Pub. Date: Jul. 8, 2004

(54) Substantially airtight register box for HVAC systems

(76) Inventors: Michael D. Stepp, Fort Worth, TX (US); Chris A. Van Rite, Springtown, TX (US)

Correspondence Address: James E. Bradley, BRACEWELL & PATTERSON, LLP, P.O. Box 61389, Houston, TX, 77208-1389, US

(21) Appl. No.: 10/335,781

(22) Filed: Jan. 2, 2003

(51) Int. Cl. F16L 25/00

(52) U.S. Cl. 285/424

(57) ABSTRACT

A substantially airtight ducting enclosure is provided for a heating, ventilation, and/or air conditioning system. The enclosure, which may be a register box for return air or supply air, has a body formed from at least one planar sheet, the body having an inlet and an outlet. At least one of the inlet and the outlet is formed by folding corners of the planar sheet to form planar sides that lie in intersecting planes. The enclosure is then mounted to a surface of an interior area of a structure, and connected to ducts for communicating air between the interior area and a central air-handler unit.

### BACKGROUND OF THE INVENTION

1. Field of the Invention

This invention generally relates to ductwork for heating, ventilation, and air-conditioning (HVAC) systems and particularly relates to substantially airtight return-air or supply-air register boxes.

2. Description of the Related Art

To create desired ambient conditions within a structure, a typical HVAC system is installed for circulating and/or conditioning air drawn form the interior of the structure and returned to the interior of the structure. A central unit or several units are located in or near the structure, each unit comprising a fan for air circulation and optionally comprise a heating, humidification, or cooling system for conditioning the air passing through the central unit.

To conduct air to and from each central unit, ducting is provided in the structure. The ducting includes supply-air ducts, which provide conditioned air to the interior of the structure and are connected to the outlets of each central unit, and return-air ducts, which return air from the interior to each central unit and are connected to inlets of each central unit. Supply-air ducts typically terminate in supply-air register boxes mounted to walls, ceilings, or other surfaces within the interior, whereas return-air ducts typically begin at register boxes mounted to a surface within the interior, such as a wall, ceiling, or floor. There are usually many more register- boxes for supply air than for return air, with those for return air typically being substantially larger than those for supply air.

To increase efficiency, buildings codes are being revised to require substantially airtight HVAC systems. The typical, prior-art method for forming sheet-metal register boxes is shown in FIGS. 1 and 2. A form 11 is cut from a rectangular, planar metal sheet, the form having cutouts 13 for corners or other features to allow bending of form 11 into the desired shape. Cutouts 13 define the height of sides 15,17, and an overlapping flap 19 is formed by cutting slot 21 at each cutout 13. Sides 15, 17 are bent along bend lines (shown as broken lines in FIG. 1) to lie in intersecting planes, as shown in FIG. 2, to form an open-bottom, rectangular enclosure of a register box 23, with the vertical edges of sides 15 abutting the inside surfaces of sides 17. Flap 19 is folded around each corner to lie adjacent the outer surface of side 15 and then fastened to side 15, such as with rivets 25. To complete register box 23, a circular duct connector (not shown) is connected to circular cutout 27 in the upper surface of box 23. Prior-art register boxes are also formed with abutting edges to form the enclosure, and abutting or overlapping edges may be fastened by adhering or by other fastening means, such as spot welding.

The method described above produces ducting enclosures that often leak conditioned air through the gaps between the edges at the corners, or, in the case of enclosures formed from multiple pieces, through the seams where the pieces are joined together. The prior-art method includes many labor-intensive steps to form the enclosures, including the cutting of the planar sheet and the fastening of the edges.

Ducting enclosures having seamless corners would substantially eliminate the leakage of air from the enclosure and reduce the cost of production. Therefore, there is a need for ducting enclosures, such as register boxes, having seamless corners formed from a planar sheet without corner cutouts. In addition, there is a need for a method of forming substantially airtight ducting enclosures.

### SUMMARY OF THE INVENTION

A substantially airtight ducting enclosure is provided for a heating, ventilation, and/or air conditioning system. The enclosure, which may be a register box for return air or for supply air, has a body formed from at least one planar sheet, the body having an inlet and an outlet. At least one of the inlet and the outlet is formed by folding corners of the planar sheet to form planar sides that lie in intersecting planes. The planar sheet lacks corner cutouts, and the corners of the sheet are folded into a corner wing that is then positioned adjacent one of the sides. The enclosure is then mounted to a surface of an interior area of a structure, and connected to ducts for communicating air between the interior area and a central air-handler unit.

### BRIEF DESCRIPTION OF THE DRAWINGS

The novel features believed to be characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings.

FIG. 1 is top view of a form for constructing a prior-art register box, the form being cut from a rectangular, planar section of sheet metal.

FIG. 2 is a prior-art register box constructed from the form of FIG. 1.

FIG. 3 is a perspective view of a register box formed according to the invention.

FIG. 4 is a side view of a portion of the register box of FIG. 3.

FIG. 4A is top view of a portion of the register box of FIG. 3 taken along section line 4A-4A of FIG. 4.

FIG. 5 is a top view of a form from which the register box of FIG. 3 is constructed.

FIG. 6 is a side view of a portion of the register box of FIG. 3 taken along section line 6-6 of FIG. 3.

FIG. 7 is a perspective view of an alternate embodiment of a register box according to the invention.

FIG. 8 is side view of a portion of the register box of FIG. 7.

FIG. 9 is a top view of a form for constructing one section of the register box of FIG. 7.

FIG. 10 is a side view of a portion of the register box of FIG. 7 taken along section line 10-10 of FIG. 7.

FIG. 11 is a side view of a portion of the register box of FIG. 7 taken along section line 11-11 of FIG. 7.

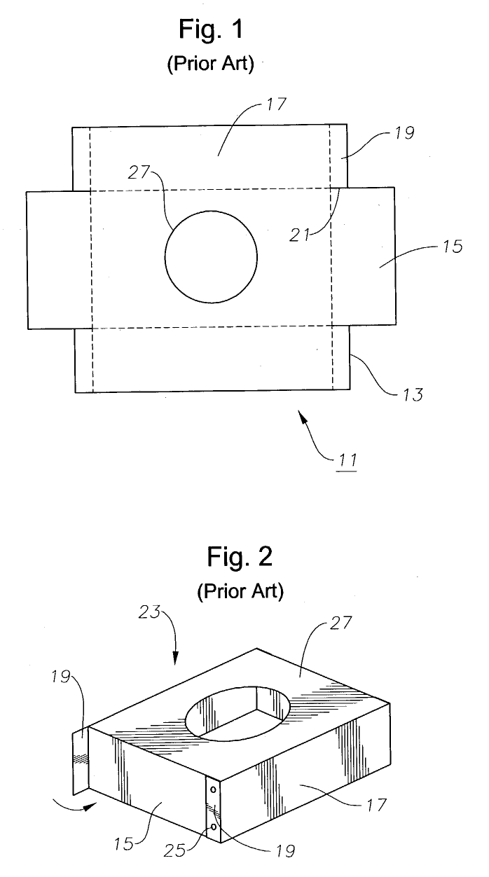

### DETAILED DESCRIPTION OF THE INVENTION

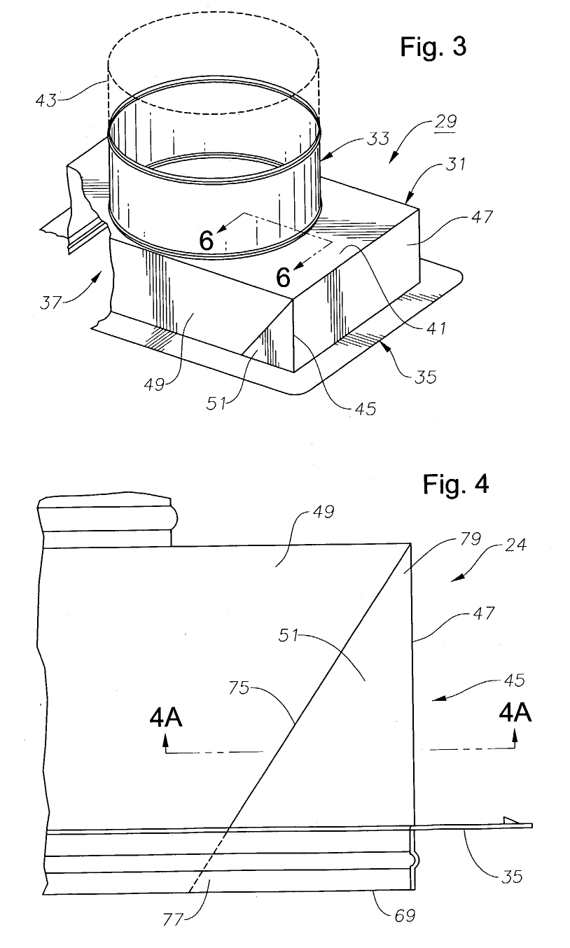

FIGS. 3 through 11 show embodiments of substantially airtight ducting enclosures according to the present invention. While the enclosures shown may not prevent all air loss in high-pressure applications, the enclosures substantially prevent all air loss at pressures found in typical air-handler, or HVAC, systems. The following description entails use of the enclosures as register boxes for supply air, though the register boxes may be used for return air, in which the direction of airflow through the enclosures is reversed from that described below.

FIG. 3 shows a register box 29 comprising a body 31, a duct connector 33, and a mounting flange 35. Body 31 is formed from a single, planar sheet of plastically deformable material, preferably sheet metal, body 31 having an outlet 37 at the bottom of body 31 and an inlet 39 formed in upper surface 41 at the top of body 31. Duct connector 33 sealingly engages inlet 39, as shown in FIG. 6 and described below, for connecting a circular duct 43 to body 31. When used for supply air, air passes through duct 43 and connector 33, into body 31 through inlet 39, and then out of body 31 through outlet 37.

Body 31 has four external corners 45, each formed at the intersection of sides 47, 49. The term “external” refers to a corner that has two edges that join to form a protruding intersection, as opposed to an inside corner that is recessed. Corners 45 are formed by bending the outer portions of a form cut from a planar sheet into intersecting plane to form sides 47, 49. During the bending, the corners of the planar sheet are each bent to form a triangular wing 51. Each wing 51 is preferably located in an angular position adjacent one of sides 47, 49, wings 51 being shown adjacent sides 49.

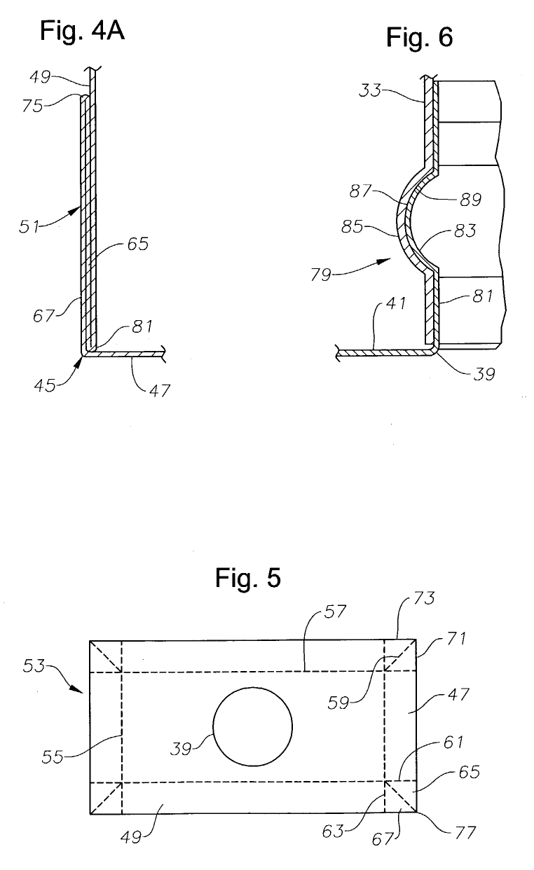

FIG. 4 is a side view of register box 29 that shows a corner wing 51, which is formed as sides 47, 49 are bent to form corners 45 at each intersection of sides 47, 49. FIG. 5 is a top view of a form 53 cut from a planar sheet and folded along the broken lines to form body 31 of register box 29. Referring to the figures, sides 47, 49 are formed by folding form 53 along lines 55, 57, respectively, with wings 51 being formed by folding the outer ends of sides 47, 49 at lines 59, 61, 63. Each wing 51 comprises two triangular sections 65, 67 that are folded to lie adjacent each other. A lower edge 69 of each wing 51 comprises end portions 71, 73 of the edges of sides 47, 49. Sections 65, 67 are joined together at creased edge 75, which forms as wing 51 is bent along line 59 and extends from a lower corner 77 of wing 51 to an upper corner 79 of wing 51.

FIG. 4A is a top, section view of one wing 51 along the section line 4A-4A of FIG. 4. Wing 51 forms as corner 77 remains in an outward position while sides 47, 49 are moved into the desired positions. As shown in the figures, sides 47, 49 are perpendicular to each other, though sides 47, 49 may be at other desired angles, for example, to form a converging or diverging section. Sections 65, 67 are connected at external edge 75, and section 65 is connected to side 49 at internal edge 81, which is generally vertical. Wing 51 may be oriented to any angular position between the planes of sides 47, 49, though it is preferable to bend wing 51 to a position adjacent one of sides 47, 49, allowing installation of mounting flange 35 (FIG. 3) and preventing injuries from contact with wing 51. In the embodiment shown in FIG. 4, wing 51 is shown as being adjacent side 49, though wing 51 may alternatively be adjacent side 47 in applications that have sufficient dimensions to limit interference of wings 51. To prevent airflow from within register box 29 from escaping through corners 45, each wing 51 is creased along edge 75, 81, placing sections 65, 67 and side 49 in a sealing relationship. Alternatively, wing 51 may be formed to lay within the interior of register 29, with wing 51 preferably rotated to be adjacent an inner surface of one of sides 47, 49.

Duct connector 33 is a tubular structure preferably connected to body 31 with joint 79, which is shown in detail in FIG. 6. A cylindrical lip 81 is formed at inlet 39, lip 81 having a circumferential, curved detent 83 for engaging a corresponding notch 85 formed on a lower portion of connector 33. Outer surface 87 of detent 83 sealingly engages inner surface 89 of notch 85 when connector 95 is installed. Joint 79 provides a substantially airtight seal between body 31 and connector 33.

Referring to FIGS. 3 through 6, to form register box 29, form 53 is formed from a planar sheet of plastically deformable material, such as sheet metal. Sides 47, 49 may be folded to lie in interesting planes simultaneously or sequentially, with each corner 77 preferably remaining in an outward position as wing 51 is formed. Each wing 51 is then rotated to lay adjacent one of sides 47, 49, and a lip 81 is formed at outlet 39. Duct connector 33 is then connected to lip 81, and mounting flange 35 is attached to body 31.

During use, register box is installed in communication with a volume, typically an interior portion of a structure, into which air is to be delivered or from which air is to be withdrawn. Mounting flange 35 allows register box 29 to be mounted on a surface, such as a ceiling, floor, or wall, though register box 29 may alternatively be attached to exposed ductwork. When used as a supply-air register box, air is delivered through duct 43 and duct connector 33, passing through inlet 39 into body 31. The air exits register box 29 through outlet 37 and into the volume. When used as a return-air register box, then direction of airflow is reversed from that described above.

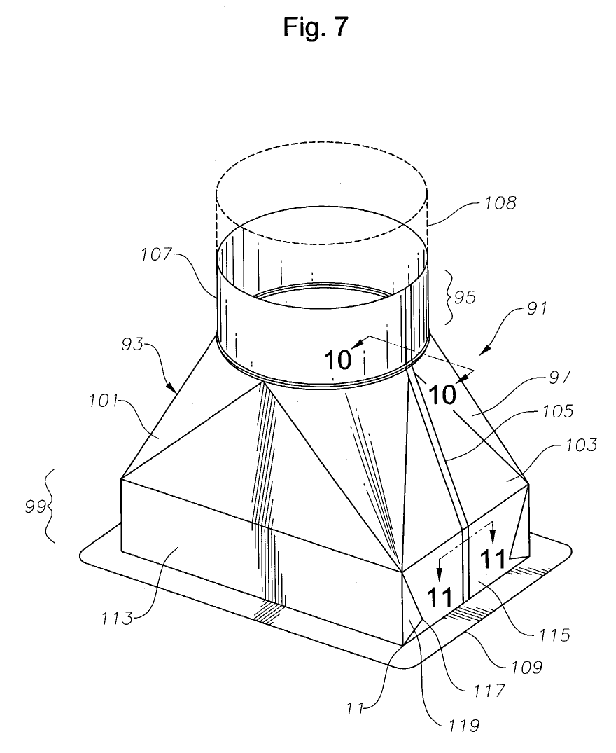

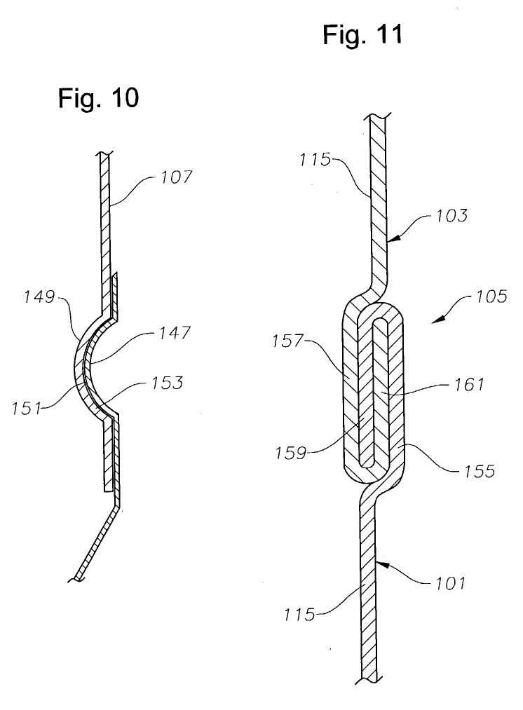

FIGS. 7 through 11 illustrate an alternative embodiment of a register box of the invention. Like register box 29 (FIG. 3), register box 91 has a body 93 formed from planar sheets of plastically deformable material, such as sheet metal, body 93 comprising an inlet 95, a converging section 97, and an outlet 99. In the embodiment shown, body 93 is assembled from two body sections 101, 103, which are preferably identical. Sections 101, 103 are sealingly joined together at opposing seams 105, which are described below and shown in FIG. 11. Alternatively, body 93 may be formed form only one section 101, 103, the edges of which would be joined by one seam 105. Inlet 95 comprises a duct connector 107 sealingly joined to body 93 to provide for connection to a tubular duct 108, and the joint between connector 107 and body 93 is shown in FIG. 10 and described below. A mounting flange 109 is attached to the outer surface of outlet 99 for mounting register box 91 to a surface within an interior of a structure.

Outlet 99 has four corners 111, which are formed as sides 113, 115 are moved to non-coplanar positions, sides 113, 115 being perpendicular in the embodiment of FIG. 7. As sides 113, 115 are moved to the desired positions, corners 117 of the planar sheet remain in outward positions, creating wings 119 and forming a seamless, airtight corner 111. Each wing 119 is preferably positioned adjacent one of sides 113, 115, and wings 119 are shown adjacent sides 115. After forming outlet 99, mounting flange 109 is attached to the outer surface of outlet 99.

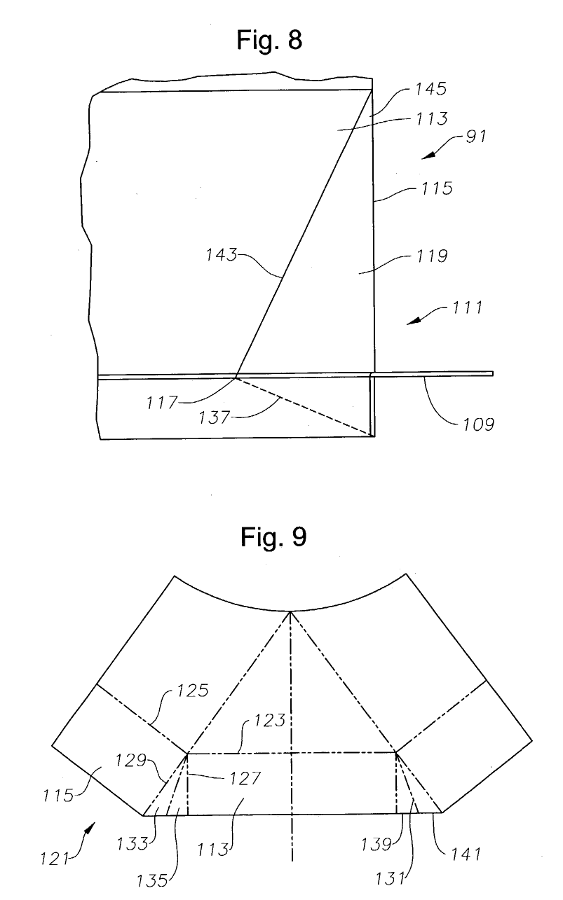

FIG. 8 is a side view of register box 91 that shows a corner wing 119, which is formed as sides 113, 115 are bent to form corners 111 at each intersection of sides 113, 115. FIG. 9 is a top view of a form 121, which is cut from a planar sheet and folded along the broken lines to form a body section 101, 103 of register box 91. Referring to the figures, sides 113, 115 are formed by folding form 121 along lines 123, 125, respectively, with wings 119 being formed by folding an area between sides 113, 115 at lines 127, 129, 131. Each wing 119 comprises two triangular sections 133, 135 that are folded to lie adjacent each other. A lower edge 137 of each wing 119 comprises portions 139, 141 of the edge of form 121. Sections 133, 135 are joined together at creased edge 143, which extends from a lower corner 117 to an upper corner 145.

The joint between duct connector 107 and body 93 is shown in cross-section in FIG. 10 A circumferential, outwardly protruding detent 147 has a curved vertical cross-section, detent 147 being sized to fit within a corresponding notch 149 formed at the lower end of connector 107. After body sections 101, 103 (FIG. 7) are joined to each other, duct connector 107 is mounted on body 93, with detent 147 being located in notch 149. Outer surface 151 of detent 147 engages inner surface 153 of notch 149, creating a substantially airtight seal between body 93 and connector 107.

FIG. 11 shows the detail of seams 105, which joins body sections 101, 103 to form body 93 (FIG. 1). Inner portions of sides 115 of each section 101, 103 are bent into U-shaped devises 155, 157, respectively, and devises 155, 157 interlock to join sections 101, 103. The inner, free portion of clevis 155 acts as a tang 159 that is sealingly received within clevis 157. Likewise, the outer, free portion of clevis 157 acts as a tang 161 that is sealingly received by clevis 155. Clevises 155, 157 cooperate to provide a substantially airtight joint along the inner edges of body sections 101, 103.

In operation, register box 91 is preferably mounted to a wall, ceiling, or other surface in communication with an interior of a structure. Mounting flange 109 is placed flush against the surface and fastened by any suitable method, such as with fasteners. A circular duct 108 is attached to duct connector 107 and to a central HVAC unit (not shown). When used as a supply-side register box, HVAC unit forces air through duct 108 and into register box 91, the air exiting through outlet 99 into the interior of the structure. Alternatively, box 91 may be used as a return-air register box, with air flowing from the interior, through register box 91, and into duct 108.

The invention has several advantages. The ducting enclosures of the invention provide for substantially airtight communication of airflow between an interior area of a structure and return-air or supply-air ducts connected to a central HVAC unit. This increases the efficiency of the HVAC system. Also, the invention provides for a method of forming the ducts that reduces the labor, and associated costs, of forming register boxes or vents.

While the invention has been shown or described in only some of its forms, it should be apparent to those skilled in the art that it is not so limited, but is susceptible to various changes without departing from the scope of the invention. For example, the corner wings may alternatively be folded inward into the interior of the enclosure and located adjacent an inner surface of the sides. Additionally, notches may be cut in the forms to ensure folding along the preferred lines or to provide for a desired shape of the corner wings.

I claim:

1. A substantially airtight ducting enclosure for an air-handler system, the enclosure comprising:
a body constructed from a planar form, the body having an inlet, an outlet, and a plurality of planar sides; wherein
at least one of the inlet and the outlet has external corners, each external corner having a diagonal wing with two plies folded over one another and folded over one of the planar sides.

2. The enclosure of claim 1, wherein:
the outlet is defined by the planar sides.

3. The enclosure of claim 1, wherein:
the outlet is defined by the planar sides; and wherein the enclosure further comprises
an inlet connector joined to the inlet of the body.

4. The enclosure of claim 1, wherein:
the outlet is substantially rectangular.

5. The enclosure of claim 1, wherein:
the inlet is substantially circular.

6. The enclosure of claim 1, wherein:
the outlet is substantially rectangular; and
the inlet is substantially circular.

7. The enclosure of claim 1, wherein:
the planar form has a substantially rectangular peripheral edge.

8. The enclosure of claim 1, wherein:
each wing is folded to lie outside of the body.

9. A substantially airtight ducting enclosure for an air-handler system, the enclosure comprising:
a sheet metal body having a plurality of planar sides joined at corners, the body having a top with a circular aperture and a bottom that is open; wherein
each of the corners has a first fold line that extends vertically along with one of the sides and a second fold line that extends vertically along another of the sides, the first and second fold lines joining each other at a junction and extending to the bottom of the body; and
each of the corners has a diagonal fold line that extends from the junction to the bottom of the body at a point between the first and second fold lines, defining two triangular-shaped portions that overlap one another and one of the sides.

10. The enclosure of claim 9, wherein:
the bottom is substantially rectangular.

11. The enclosure of claim 9, wherein:
the bottom is substantially rectangular and in a plane parallel to the top.

12. The enclosure of claim 9, wherein:
the bottom is substantially rectangular and the top is in the configuration of a truncated, four-sided pyramid.

13. The enclosure of claim 9, wherein:
each wing is folded to lie outside of the body.

14. A method of forming a substantially airtight ducting enclosure, the method comprising:
(a) providing a planar sheet of plastically deformable material;
(b) bending sections of the planar sheet to construct a body having an inlet and an outlet, at least one of the inlet and the outlet having a plurality of planar sides;
(c) forming seamless corners at the intersections of the sides by folding portions of the planar sheet into a corner wing at each corner.

15. The method of claim 14, wherein:
the planar sheet has a rectangular peripheral edge.

16. A method of forming a substantially airtight ducting enclosure, the method comprising:
(a) providing a planar sheet of plastically deformable material with edges intersecting to define two external corners;
(b) folding the sheet along upper fold lines parallel to the edges to form planar sides that intersect at the corners;
(c) folding the sheet to define a diagonal fold line that extends from the intersection of the upper fold line to the corner of the sheet, thereby forming two triangular portions;
(d) folding the triangular portions over each other and against one of the sides; and
(e) forming a circular opening in the sheet for connecting the enclosure to a duct.

17. The method of claim 16, wherein:
the triangular portions are formed on external surfaces of the corners.

18. The method of claim 16, wherein:
the diagonal fold line is oriented at approximately 45° relative to the edges.
